(19) United States
(12) Patent Application Publication
(10) Pub. No.: US 2025/0190819 A1
(43) Pub. Date: Jun. 12, 2025

(54) Extraction System for Corporate Knowledge Base and a Method Thereof

(71) Applicants: SQ Technology (Shanghai) Corporation, Shanghai (CN); Inventec Corporation, Taipei City (TW)

(72) Inventors: Ming Lu, Shanghai (CN); Qiu-Long Jing, Shanghai (CN); Yan-Xiang Chen, Shanghai (CN); Po-Shuo Chiu, Taipei City (TW)

(21) Appl. No.: 18/601,479

(22) Filed: Mar. 11, 2024

(30) Foreign Application Priority Data
Dec. 6, 2023 (CN) 202311669084.3

(51) Int. Cl. G06N 5/022

(52) U.S. Cl. CPC G06N 5/022

(57) ABSTRACT

An extraction system for corporate knowledge base and a method thereof are disclosed. In the extraction system, a server-end device receives a key word, the key word is vectorized to perform a vector search in a company knowledge base, and a search result is labelled to generate a new vector which is then stored in the company knowledge base. The vector search is again performed on the company knowledge base based on the keyword vector.

### CROSS-REFERENCE TO RELATED APPLICATION

This application claims the benefit of Chinese Application Serial No. 202311669084.3, filed Dec. 6, 2023, which is hereby incorporated herein by reference in its entirety.

### BACKGROUND OF THE INVENTION

### 1. Field of the Invention

The present invention relates to a data extraction system and a method thereof, more particularly to an extraction system for corporate knowledge base and a method thereof.

### 2. Description of the Related Art

In recent years, with the popularity and vigorous development of big data analysis, various big data analysis applications have sprung up. However, how to accurately obtain valuable information from big data has always been an issue that manufacturers are eager to solve.

Generally speaking, conventional data search method includes exact matching and fuzzy matching, for example, assuming the first phrase is “earthling” and the second phrase is “earth,” using exact matching considers that these two terms do not match each other, while using fuzzy matching considers that these two terms match with each other. However, as the number of characters increases, it becomes challenging to determine whether the data is similar, regardless of using exact matching or fuzzy matching. Therefore, there is an issue with the low accuracy of data search.

For this reason, some companies have proposed the use of the vector search technology, which vectorizes the text and then determines whether sentences are the same or similar based on their similarity distance. However, when dealing with a large amount of data, directly vectorizing all content significantly affects the accuracy of vector search, leading to the same issue of poor accuracy in data search.

According to above-mentioned contents, what is needed is to develop an improved technical solution to solve the problem of poor accuracy in data search.

### SUMMARY OF THE INVENTION

An objective of the present invention is to disclose an extraction system for corporate knowledge base and a method thereof.

In order to achieve the objective, the present invention discloses an extraction system for corporate knowledge base, and the extraction system includes a company knowledge base and a server-end device. The company knowledge base is configured store pieces of patent raw data, wherein each of the pieces of patent raw data corresponds to at least one math vector. The server-end device is linked to the company knowledge base through network. The server-end device includes a non-transitory computer-readable storage medium and a hardware processor. The non-transitory computer-readable storage medium is configured to store computer readable instructions. The hardware processor is electrically connected to the non-transitory computer-readable storage medium, and configured to execute the computer readable instructions to make the server-end device execute: receiving at least one key word, and vectorizing each of the at least one key word to generate a key vector; transmitting the key vector to the company knowledge base to be compared with the math vectors, and when the key vector matches one of the math vectors, receiving the piece of patent raw data corresponding to the one of the math vectors from the company knowledge base, and integrate and generate a search result; outputting the search result, and perform labelling on the piece of patent raw data of the search result, to generate at least one label message; vectorizing the at least one label message to generate a label vector, and storing the label vector to the company knowledge base as the math vector corresponding to the labelled patent raw data; transmitting the key vector to the company knowledge base to be compared with the math vector, integrating the search result, and outputting the search result, again.

In order to achieve the objective, the present invention discloses an extraction method for company knowledge base, includes steps of: linking the company knowledge base and the server-end device through network, wherein the company knowledge base stores pieces of patent raw data, and each of the pieces of patent raw data corresponds to at least one math vector, and the server-end device comprises a non-transitory computer-readable storage medium storing computer readable instruction, and a hardware processor executing the computer readable instruction; receiving at least one key word, and vectorizing each of the at least one key word to generate a key vector, by the server-end device; transmitting the key vector to the company knowledge base to be compared with the math vectors, and when the key vector matches one of the math vectors, receiving the piece of patent raw data corresponding to the one of the math vectors from the company knowledge base, and integrating and generating a search result, by the server-end device; outputting the search result, and labelling the patent raw data in the search result to generate at least one label message, by the server-end device; vectorizing the label message to generate a label vector, and storing the label vector to the company knowledge base as a math vector corresponding to the labelled patent raw data, by the server-end device; transmitting the key vector to the company knowledge base to be compared with the math vectors, integrating the search result, and outputting the search result again, by the server-end device.

According to the above-mentioned system and method of the present invention, the difference between the present invention and the conventional technology is that, in the invention, the server-end device receives the key word, the key word is then vectorized to perform the vector search in the company knowledge base, and the search result is labelled to generate the new vector which is then stored in the company knowledge base, and the vector search is again performed on the company knowledge base based on the keyword vector, so as to obtain the more accurate data.

Therefore, the above-mentioned solution of the present invention is able to achieve the effect of improving the accuracy of data search.

### BRIEF DESCRIPTION OF THE DRAWINGS

The structure, operating principle and effects of the present invention will be described in detail by way of various embodiments which are illustrated in the accompanying drawings.

FIG. 1 is a block diagram of an extraction system for corporate knowledge base, according to the present invention.

FIG. 2A and FIG. 2B are flowchart of an extraction method for corporate knowledge base, according to the present invention.

FIG. 3 is a schematic view showing an operation of data extraction, according to an application of the present invention.

FIG. 4 is a schematic view showing an operation of setting chat and similarity, according to an application of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first,’ ‘second,’ ‘third,’ and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include,” and variations such as “comprises,” “comprising,” “includes,” or “including,” will be acknowledged to imply the inclusion of stated elements but not the exclusion of any other elements.

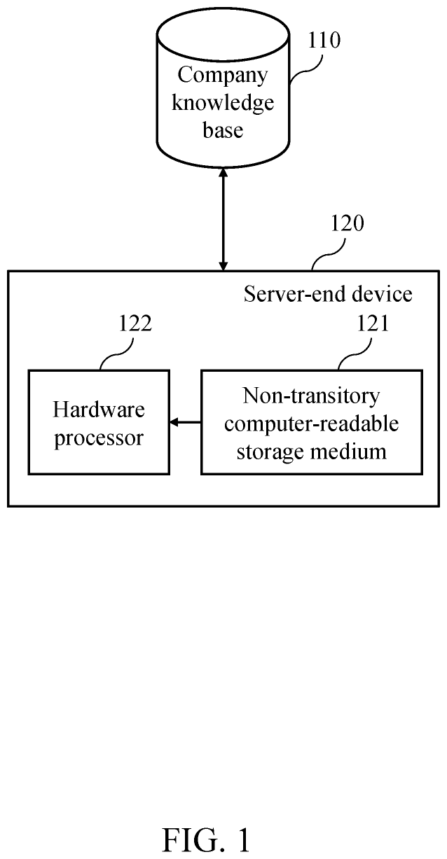

Please refer to FIG. 1. FIG. 1 is a block diagram of an extraction system for corporate knowledge base, according to the present invention. The extraction system includes a company knowledge base 110 and a server-end device 120. The company knowledge base 110 is configured to store multiple pieces of patent raw data, each of the pieces of patent raw data corresponds to a math vector. In actual implementation, each of the pieces of the patent raw data includes a case status, so that when the server-end device 120 integrates the search result, the case status corresponding to the patent raw data can be embedded in the search result. In addition, the patent raw data includes an inventor message, so that when the server-end device 120 integrates the search result, the pieces of the patent raw data having the same inventor message can be selected from the company knowledge base 110 to build the association recommendation, and the association recommendation can be embedded into the re-integrated the search result.

The server-end device 120 is linked to the company knowledge base 110 through network, the server-end device 120 includes a non-transitory computer-readable storage medium 121 and a hardware processor 122. In actual implementation, the non-transitory computer-readable storage medium 121 may include a hard disk, an optical disk, a flash memory, or the like. The non-transitory computer-readable storage medium 121 is configured to store computer readable instructions. The computer readable instructions can be assembly language instructions, instruction-set-structure instructions, machine instructions, machine-related Instructions, micro-instructions, firmware instructions, or source codes or object codes written in any combination of one or more programming languages. The programming language includes object-oriented programming languages, such as: Common Lisp, Python, C++, Objective-C, Smalltalk, Delphi, Java, Swift, C#, Perl, Ruby, or PHP; the programming language can include regular procedural programming languages, such as C language or similar programming languages. In addition, the server-end device 120 receives at least one conversation message, and extracts the key word from the at least one conversation message based on a natural language processing technology, and stores at least one of the at least one conversation message and the key word, for example, at least one of the at least one conversation message and the key word can be stored in a storage device, the company knowledge base 110, or the like. In actual implementation, the natural language processing technology can be implemented by coupling to an application programming interface (API) of a deep learning model, such as Generative Pre-trained Transformer (GPT).

The hardware processor 122 is electrically connected to the non-transitory computer-readable storage medium 121, and configured to execute the computer readable instructions, to make the server-end device 120 execute the following operations of: receiving the key word, and vectorizing the key word to generate key vector, respectively; transmitting the key vector to the company knowledge base 110 to be compared with the math vectors, and when the key vector matches one of the math vectors, receiving the patent raw data corresponding to the one of the math vectors from the company knowledge base 110, and integrating the received piece of patent raw data into a search result; outputting the search result, and labelling the piece of patent raw data in the search result to generate a label message; vectorizing the label message to generate a label vector, and storing the label vector to the company knowledge base 110 as the math vector corresponding to the labelled piece of patent raw data, transmitting the key vector to the company knowledge base 110 to be compared with the math vectors again, integrating the received piece of patent raw data into the search result, and outputting the search result. In actual implementation, the hardware processor 122 can be a central processing unit, a microprocessor, or the like. In additional, the search result can perform the labelling operation by at least one of an automatic manner and a manual manner, and select an approximate vocabulary as the label message based on the natural language processing technology.

It is to be particularly noted that, in actual implementation, the above-mentioned solution of the present invention can be implemented fully or partly based on hardware, for example, one or more component of the system can be implemented by hardware processor, such as integrated circuit chip, system on chip (SoC), a complex programmable logic device (CPLD), or a field programmable gate array (FPGA). The non-transitory computer-readable storage medium records computer readable program instructions, and the processor can execute the computer readable program instructions to implement concepts of the present invention. The non-transitory computer-readable storage medium can be a tangible apparatus for holding and storing the instructions executable of an instruction executing apparatus. The non-transitory computer-readable storage medium can be, but not limited to electronic storage apparatus, magnetic storage apparatus, optical storage apparatus, electromagnetic storage apparatus, semiconductor storage apparatus, or any appropriate combination thereof. More particularly, the non-transitory computer-readable storage medium can include a hard disk, an RAM memory, a read-only-memory, a flash memory, an optical disk, a floppy disc, or any appropriate combination thereof, but this exemplary list is not an exhaustive list. The non-transitory computer-readable storage medium is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable program instruction can be downloaded from the non-transitory computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub and/or gateway. The network card or network interface of each calculating/processing apparatus can receive the computer readable program instructions from network, and forward the computer readable program instruction to store in non-transitory computer-readable storage medium of each calculating/processing apparatus.

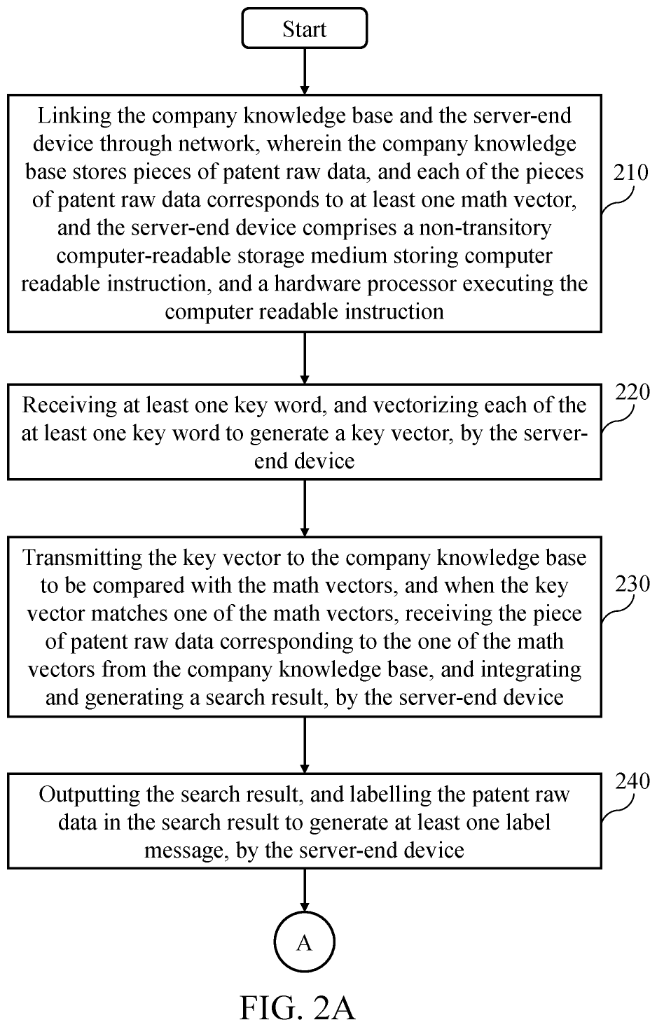

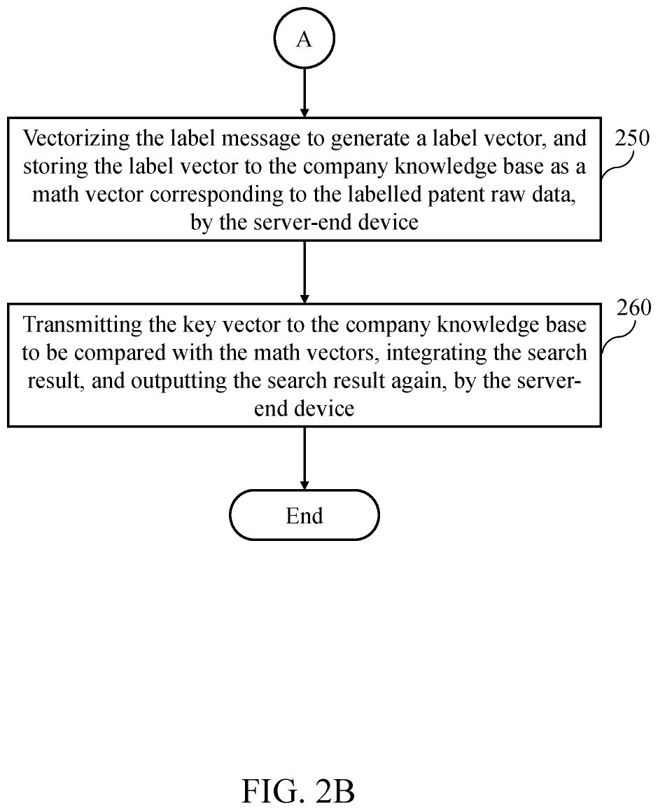

Please refer to FIG. 2A and FIG. 2B. FIG. 2A and FIG. 2B are flowcharts of an extraction method for company knowledge base, according to the present invention. As shown in FIG. 2A and FIG. 2B, the extraction method includes the following steps. In a step 210, the company knowledge base 110 is linked to the server-end device 120 through network, wherein the company knowledge base 110 stores pieces of patent raw data, and each of the pieces of patent raw data corresponds to at least one math vector, and the server-end device 120 includes a non-transitory computer-readable storage medium 121 storing computer readable instruction, and a hardware processor 122 executing the computer readable instruction. In a step 220, the server-end device 120 receives at least one key word and vectorizes each of the at least one key word to generate a key vector. In a step 230, the server-end device 120 transmits the key vector to the company knowledge base 110 to be compared with the math vectors, and when the key vector matches one of the math vectors, the server-end device 120 receives the piece of patent raw data corresponding to the one of the math vectors from the company knowledge base 110, and integrates and generates a search result. In a step 240, the server-end device 120 outputs the search result, and labels the patent raw data in the search result to generate at least one label message. In a step 250, the server-end device 120 vectorizes the label message to generate a label vector, and stores the label vector to the company knowledge base 110 as a math vector corresponding to the labelled patent raw data. In a step 260, the server-end device transmits the key vector to the company knowledge base 110 to be compared with the math vectors, integrating the search result, and outputting the search result again. Through aforementioned steps, the server-end device 120 can receive the key word, the key word is then vectorized to perform the vector search in the company knowledge base 110, and the search result is labelled to generate the new vector which is then stored in the company knowledge base 110, and the vector search is again performed on the company knowledge base 110 based on the keyword vector, so as to obtain the more accurate data.

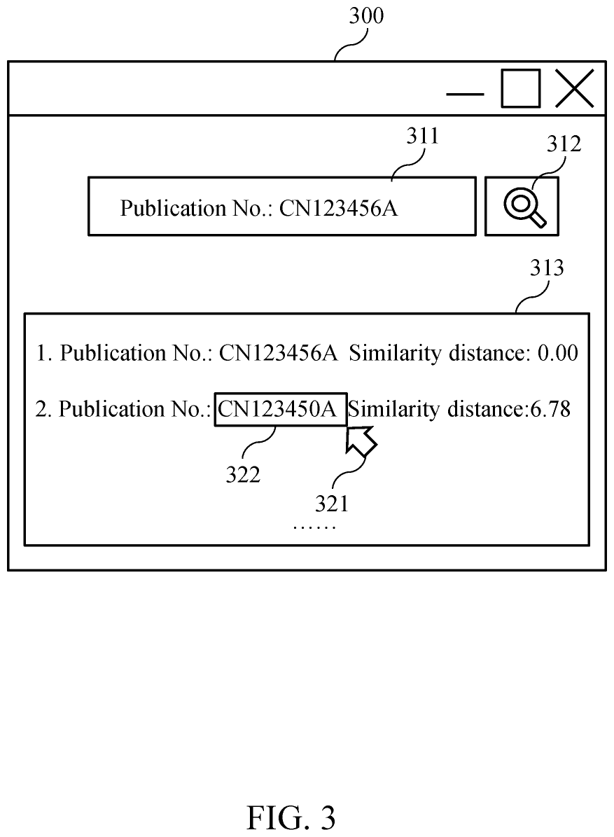

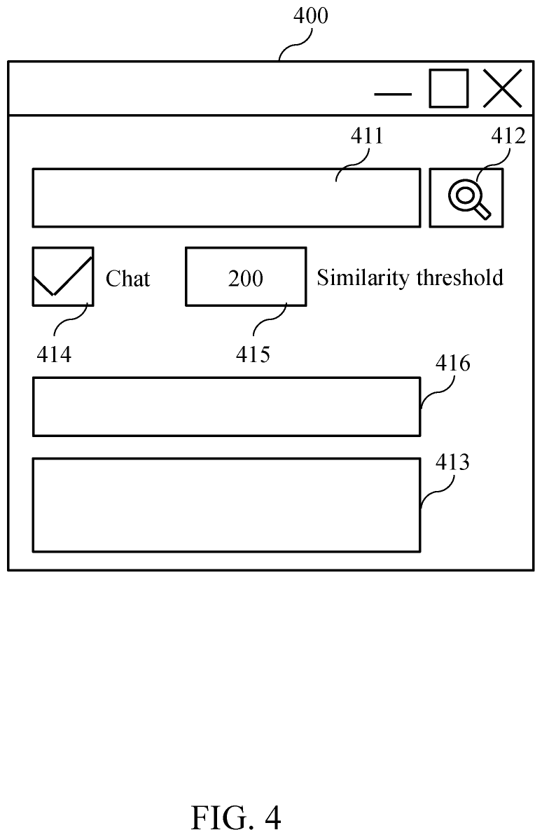

An embodiment of the present invention will be illustrated in the following paragraphs with reference to FIG. 3 and FIG. 4. Please refer to FIG. 3. FIG. 3 is a schematic view showing an operation of data extraction, according to an application of the present invention. In actual implementation, a user can directly open a search window 300 in a terminal machine, input the key word for search in an input block 311, such as “publication number: CN123456A”, and click a search button 312 to transmit the key word to the server-end device 120. After the server-end device 120 receives the key word, the server-end device 120 vectorizes the received key word to generate a key vector, for example, the key word “publication number: CN123456A” can be vectorized to generate a set of numbers to express the vector of the key word. In actual implementation, the vectorization manner can use, for example, Word2Vec, TF-IDF, BERT or similar model to perform feature extraction to generate the key vector. Next, the server-end device 120 transmits the key vector to the company knowledge base 110 to compare the key vector with the math vectors stored in the company knowledge base 110. It is to be particularly noted that the key vector and the math vectors are generated by the same vectorization manner. When the key vector matches one of the math vectors, the server-end device 120 receives the piece of patent raw data corresponding to the one of the math vectors from the company knowledge base 110, such as the pieces of patent raw data having publication number “CN123456A” and “CN123450A”, to integrate the search result, and display the search result on a first output block 313. In actual implementation, the key vector and the one of the math vectors matching each other means a difference (a similarity distance) between the one of the math vectors and the key vector is within a specific range (such as a value of 60); a smaller difference means a higher similarity, and a larger difference means a lower similarity. It is to further explain that, besides being opened in the terminal machine directly, the search window 300 can be directly opened through a webpage by a browser provided to the user by the server-end device 120.

The server-end device 120 permits the user to label the patent raw data of the search result on the first output block 313, for example, the user can drag and drop a cursor 321 to drag-and-drop to select a label 322 to generate a label message, such as, “CN12345” shown in FIG. 3. The server-end device 120 uses the same manner to vectorize the label message to generate the label vector, and store the label vector to the company knowledge base 110, as the math vector corresponding to the labelled patent raw data. The server-end device 120 transmits the key vector to the company knowledge base 110 to be compared with the math vectors again, and when the key vector matches one of the match vectors, the server-end device 120 receives the patent raw data corresponding to the math vector from the company knowledge base 110, to integrate to the search result and display the search result on the first display block 313. It is to further explain that, besides manual labelling manner, the server-end device 120 can automatically label a piece of patent raw data based on feature phrases, for example the server-end device 120 can automatically label professional terms in patent field in the patent raw data. Therefore, performing the labelling and vectorization operations again is able to enrich the math vectors of patent raw data and improve accuracy in data search, so that the user can obtain valuable intelligence accurately from the company knowledge base 110.

Please refer to FIG. 4. FIG. 4 is a schematic view of an operation of setting chat and similarity, according to an application of the present invention. The search window 400 is taken as example. Besides the input block 411, the search button 412 and the first output block 413, the search window 400 can include a chat selection block 414 and a similarity setting block 415. After a user selects the chat selection block 414, the similarity setting block 415 is also displayed for the user to set a similarity value. When the user clicks the search button 412, the server-end device 120 receives the key word in the input block 411 and the similarity value set by the user, and inputs the key word and the similarity value to generative pre-trained transformer (GPT) model as a question and a condition, to obtain the answer and output the answer to a second output block 416 for display.

According to above-mentioned contents, the difference between the present invention and the conventional technology is that, in the invention, the server-end device receives the key word, the key word is then vectorized to perform the vector search in the company knowledge base, and the search result is labelled to generate the new vector which is then stored in the company knowledge base, and the vector search is again performed on the company knowledge base based on the keyword vector, so as to obtain the more accurate data. Therefore, the above-mentioned solution of the present invention is able to solve the conventional problem, so as to improve the accuracy of data search.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An extraction system for a corporate knowledge base, comprising:
a company knowledge base, configured to store one or more pieces of patent raw data, wherein each of the pieces of patent raw data corresponds to at least one math vector; and
a server-end device, linked to the company knowledge base through a network, wherein the server-end device comprises:
a non-transitory computer-readable storage medium, configured to store one or more computer readable instructions; and
a hardware processor, electrically connected to the non-transitory computer-readable storage medium, and configured to execute the computer readable instructions to make the server-end device execute:
receiving at least one key word, and vectorizing each of the at least one key word to generate a key vector;
transmitting the key vector to the company knowledge base to be compared with the math vectors, and when the key vector matches one of the math vectors, receiving the piece of patent raw data corresponding to the one of the math vectors from the company knowledge base, and integrating and generating a search result, based on the matching;
outputting the search result, and performing labelling on the piece of patent raw data of the search result, to generate at least one label message;
vectorizing the at least one label message to generate a label vector, and storing the label vector to the company knowledge base as the math vector corresponding to the labelled patent raw data; and
transmitting the key vector to the company knowledge base to be compared with the math vector, integrating the search result, and outputting the search result, again.

2. The extraction system for a corporate knowledge base according to claim 1, wherein the server-end device receives at least one conversation message, extracts the key word from the conversation message based on a natural language processing technology, and stores at least one of the at least one conversation message and the key word.

3. The extraction system for corporate knowledge base according to claim 2, wherein the search result is labelled by at least one of an automatic manner and a manual manner, and an approximate vocabulary is selected as the label message based on the natural language processing technology.

4. The extraction system for a corporate knowledge base according to claim 1, wherein one of the pieces of the patent raw data comprises a case status, and wherein when the search result is re-integrated, the case status corresponding to the received piece of patent raw data is embedded in the search result.

5. The extraction system for a corporate knowledge base according to claim 1, wherein one of the pieces of patent raw data comprises an inventor message, and wherein when the search result is re-integrated, the server-end device selects the piece of patent raw data having the same inventor message as the piece of patent raw data received from the company knowledge base, to build an association recommendation, and embeds the association recommendation into the re-integrated search result.

6. An extraction method for a corporate knowledge base, comprising:
linking a company knowledge base and a server-end device through network, wherein the company knowledge base stores one or more pieces of patent raw data, wherein each of the pieces of patent raw data corresponds to at least one math vector, and wherein the server-end device comprises a non-transitory computer-readable storage medium storing one or more computer readable instructions, and a hardware processor executing the computer readable instructions to make the server-end device execute:
receiving at least one key word, and vectorizing each of the at least one key word to generate a key vector, by the server-end device;
transmitting the key vector to the company knowledge base to be compared with the math vectors, and when the key vector matches one of the math vectors, receiving the piece of patent raw data corresponding to the one of the math vectors from the company knowledge base, and integrating and generating a search result based on the matching, by the server-end device;
outputting the search result, and labelling the patent raw data in the search result to generate at least one label message, by the server-end device;
vectorizing the label message to generate a label vector, and storing the label vector to the company knowledge base as a math vector corresponding to the labelled patent raw data, by the server-end device; and
transmitting the key vector to the company knowledge base to be compared with the math vectors, integrating the search result, and outputting the search result again, by the server-end device.

7. The extraction method for a corporate knowledge base according to claim 6, wherein the server-end device receives at least one conversation message, extracts the key word from the conversation message based on a natural language processing technology, and stores at least one of the at least one conversation message and the key word.

8. The extraction method for a corporate knowledge base according to claim 7, wherein the search result is labelled by at least one of an automatic manner and a manual manner, and an approximate vocabulary is selected as the label message based on the natural language processing technology.

9. The extraction method for a corporate knowledge base according to claim 6, wherein one of the pieces of the patent raw data comprises a case status, and wherein when the search result is re-integrated, the case status corresponding to the received piece of patent raw data is embedded in the search result.

10. The extraction method for a corporate knowledge base according to claim 6, wherein one of the pieces of patent raw data comprises an inventor message, and wherein when the search result is re-integrated, the server-end device selects the piece of patent raw data having the same the inventor message as the piece of patent raw data received from the company knowledge base, to build an association recommendation, and embeds the association recommendation into the re-integrated the search result.
